(19) United States
(12) Patent Application Publication
(10) Pub. No.: US 2006/0212830 A1
(43) Pub. Date: Sep. 21, 2006

(54) Graphical messaging system

(76) Inventor: Brian J. Fogg, Healdsburg, CA (US)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/261,968

(22) Filed: Oct. 27, 2005

Related U.S. Application Data
(63) Continuation-in-part of application No. 10/659,580, filed on Sep. 9, 2003.
(60) Provisional application No. 60/717,945, filed on Sep. 16, 2005.

(51) Int. Cl. G06F 17/00

(52) U.S. Cl. 715/835

(57) ABSTRACT

A method and system is described herein for messaging on a computer using a communications interface. The communications interface includes a section which displays graphics representing receivers and senders of messages. The communications interface also includes a section which facilitates the user to create, send, receive, and archive messages. Messages are created from audio or typed inputs from the user. A user communicates with other users over a network, such as the Internet.

### CROSS-REFERENCE TO RELATED APPLICATIONS

This is a continuation-in-part of prior U.S. patent application Ser. No. 10/659,580, filed on Sep. 9, 2003, and priority is claimed from U.S. Provisional Patent Application No. 60/717,945 filed on Sep. 16, 2005, each of which is incorporated herein by reference in its entirety

### BACKGROUND OF THE INVENTION

1). Discussion of Related Art

Electronic communication over networks, such as telephones, is well-known. Recently computer networks have been used to facilitate communication between computer users. E-mail is a common method of communication between computer users.

E-mail commonly uses a communication interface displayed on a computer screen. Typically the user enters an e-mail address of a recipient. The user can then type a message and send it to the recipient.

E-mail is a text-based messaging system. Audio messages cannot be easily transmitted via e-mail. Currently the only method is to save an audio message with a different software program, and send it as an attachment to another user. This is an inefficient method because it involves various software programs. Also, the receiver of a message may not have the capability to listen to the attachment if he/she does not have the correct corresponding software. The attachment files may also be too large to efficiently send via e-mail.

E-mail also lacks to a large degree any emotional feeling a sender wishes to impart with his/her message. Without a vocal inflection carrying emotion, an e-mail may be interpreted to have certain feelings when exactly the opposite is intended.

Telephone systems offer a method of audio communication, but telephones require a live conversation. While a user may leave phone messages, the user still must call a contact while not necessarily wishing to participate in a live conversation. Telephone systems are also inefficient when a user wishes to contact a group of contacts with the same message. Typically this method involves pressing a large number of button commands on a numerical telephone keypad. Telephone messaging also does not offer a user-friendly method to keep a historical record of all phone messages. Typically the user must manage messages using a numerical telephone keypad while listening to recorded voice commands.

Thus there is a need for a communication system which enables users to easily and efficiently send, receive, and manage audio messages using computer systems connected to a network. There is also a need to interface a communication system with a visual interface.

### SUMMARY OF THE INVENTION

The invention provides a method of creating and sending a message, including displaying a message interface having a selectable recording function and sending function, on a computer screen; recording an audio message when a user selects the recording function; and sending the audio message to a recipient when the user selects the sending function. The method may additionally include displaying an icon representing the recipient. The icon may be selected by the user when the message interface is displayed. The text of the audio message may be displayed on the message interface as the audio message is being recorded. The method may additionally include sending a text version of the audio message to the recipient. Selecting the recording function may be executed by a mouse-click on an icon. Selecting the sending function may be executed by a mouse-click on an icon. The message interface also may have a selectable stopping function. The message interface also may have a selectable playing function.

The invention provides a method of communicating, including selecting on a computer screen a recipient identifier; recording an audio message directly after selecting the recipient identifier, when selecting a recording function on the computer screen; and sending the audio message to at least one recipient, represented by the recipient identifier, when selecting a sending function on the computer screen.

The invention provides a computer program including a computer-useable medium having computer-readable program code embedded therein for creating and sending a message, including computer-readable program code configured to display a message interface having a selectable recording function and sending function, on a computer screen; computer-readable program code configured to record an audio message when a user selects the recording function; and computer-readable program code configured to send the audio message to a recipient when the user selects the sending function.

The invention provides a system for creating and sending a message, including at least one client computer system configured to display a message interface having a selectable recording function and sending function, on a computer screen; enable a user to record an audio message when a user selects the recording function; and enable a user to send the audio message to a recipient when the user selects the sending function.

The invention provides a system for creating and sending a message, including a plurality of client computer systems configured to display a message interface having a selectable recording function and sending function, on a computer screen; enable a user to record an audio message when a user selects the recording function; enable a user to send the audio message to a recipient when the user selects the sending function; at least one server computer system configured to facilitate sending the message; and at least one network to transmit the message thereon.

The invention provides a method of visually indicating a recipient of a message, including displaying a plurality of recipient graphics, each representing at least one recipient, on a computer screen; picking at least one of the recipient graphics to create a ring at least partially around said at least one recipient graphic; creating a message; and sending the message to said at least one recipient corresponding to the ring.

The recipient graphic may be an icon.

The recipient graphic may be a picture.

The ring may entirely surround the graphic.

Picking at least one of the recipient graphics may be performed after displaying a plurality of recipient graphics.

The plurality of recipient graphics may be located in a recipient section on the computer screen.

The recipient section may be circular.

The computer screen may have a message section separable from the recipient section. The computer screen may have a message section which has controls for creating messages, listening to messages, and setting preferences.

The message section may have controls for archiving messages.

The recipient section may further include displaying a sender graphic, representing at least one sender of the message.

Picking the recipient graphic may be executed by moving a cursor over a graphic and clicking it with a mouse.

The message may be created by recording an audio message and converting the audio message to a digital message.

Creating a message may be performed after picking said at least one recipient.

The invention provides a method of visually indicating a recipient of a message, including displaying a plurality of recipient icons on a computer screen; picking at least one of the recipient icons to create a visual at least partially around the recipient icon; creating a message; and sending the message to a recipient corresponding to said at least one recipient icon with the visual.

The invention provides a computer program including a computer-useable medium having computer-readable program code embedded therein for visually indicating a recipient of a message, the computer program including computer-readable program code configured to display a plurality of recipient graphics, each representing at least one recipient, on a computer screen; computer-readable program code configured to create a ring at least partially around said at least one recipient graphic when a user picks at least one of the recipient graphics; computer-readable program code configured to enable a user to electronically create a message; and computer-readable program code configured to send the message to said at least one recipient corresponding to the ring.

The invention provides a system for visually indicating a recipient of a message, including at least one client computer system configured to: display a plurality of recipient graphics, each representing at least one recipient, on a computer screen; enable a user to pick at least one of the recipient graphics to create a ring at least partially around said at least one recipient graphic; enable a user to electronically create a message; and enable a user to electronically send the message to at least one recipient.

The invention provides a system for visually indicating a recipient of a message, including a plurality of client computer systems configured to: display a plurality of recipient graphics, each representing at least one recipient, on a client computer screen; enable a user to pick at least one of the recipient graphics to create a ring at least partially around said at least one recipient graphic; enable a user to electronically create a message; enable a user to electronically send the message to at least one recipient; at least one server computer system configured to facilitate sending a message between the client computer systems; and at least one network to transmit the message thereon.

The invention provides a method of displaying a message section on a computer screen, including displaying a plurality of graphics, each having a graphic representing at least one recipient and having an information portion which has a plurality of functions, on a computer screen; picking one of the functions; and displaying the message section on the computer screen in response to the picking of one of the functions, the message section having controls for creating and receiving messages relating to the recipient. The graphic may be an icon. The graphic may be a picture. The information portion may be located at the bottom portion of the graphic. One of the functions may be an icon. Picking one of the functions may be executed by a mouse-click. Displaying a message section on the computer screen may occur after picking one of the functions. One of the functions may relate to the controls for creating messages. The controls for creating messages may include controls to create, play, and send messages. One of the functions may relate to the controls for receiving messages. The controls for receiving messages may include controls for playing, stopping, and replying to messages. The controls for receiving messages may include a control to rewind a message at set time intervals. The message may be audio. The message section may additionally include controls for archiving messages. The message section may additionally include controls for setting preferences.

The invention provides a computer program including a computer-useable medium having computer-readable program code embedded therein for displaying a message section on a computer screen, including computer-readable program code configured to display a plurality of graphics, each having a graphic representing at least one recipient and having an information portion which has a plurality of functions, on a computer screen; computer-readable program code configured to enable a user to pick one of the functions; and computer-readable program code configured to display the message section on the computer screen in response to the picking of one of the functions, the message section having controls for creating and receiving messages relating to the recipient.

The invention provides a system for displaying a message section on a computer screen, including at least one client computer system configured to: display a plurality of graphics, each having a graphic representing at least one recipient and having an information portion which has a plurality of functions, on a computer screen; enable a user to pick one of the functions; and display the message section on the computer screen in response to a user picking of one of the functions, the message section having controls for creating and receiving messages relating to the recipient.

The invention provides a system for displaying a message section on a computer screen, including a plurality of client computer systems configured to: display a plurality of graphics, each having a graphic representing at least one recipient and having an information portion which has a plurality of functions, on a computer screen; enable a user to pick one of the functions; display the message section on the computer screen in response to a user picking of one of the functions, the message section having controls for creating and receiving messages relating to the recipient; at least one server computer system configured to facilitate sending and receiving of the message between the client computer systems; and at least one network to transmit the message thereon.

### BRIEF DESCRIPTION OF THE DRAWINGS

The invention is further described by way of example with reference to the accompanying drawings, wherein:

FIG. 1 is a front view of a communication interface including a contact area and a communications area, according to an embodiment of the invention, a message-creating field is in the forefront of the communications area;

FIG. 2 is a front view of a multifunction icon in the communication interface as described above;

FIG. 3 is a front view of the communication interface as described above, with a listen field in the forefront of the communications area;

FIG. 4 is a front view of the communications interface as described above, with an information field in the forefront of the communications area;

FIGS. 5 and 6 are flow charts illustrating creating a message;

FIGS. 7 and 8 are flow charts illustrating listening to a message;

FIG. 9 is a front view of the communications interface as described above, illustrating how multiple messages on a common topic are managed;

FIGS. 10 and 11 are flow charts illustrating retrieving and creating contact information;

FIG. 12 is a front view of the communication interface on a client computer system;

FIG. 13 is a flow chart of a client computer system connected to a network; and

FIG. 14 is a flow chart of a plurality of client computer systems connected to a network and a server.

### DETAILED DESCRIPTION OF THE INVENTION

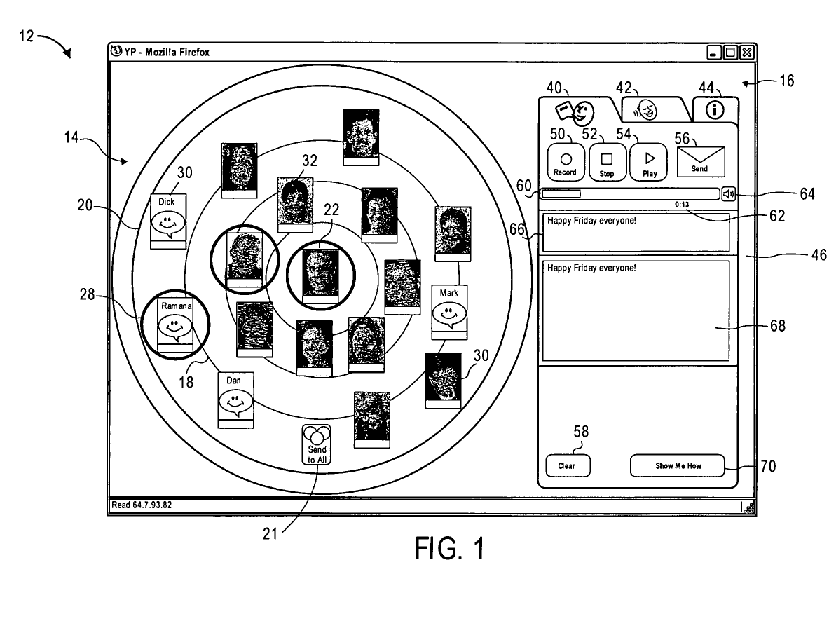

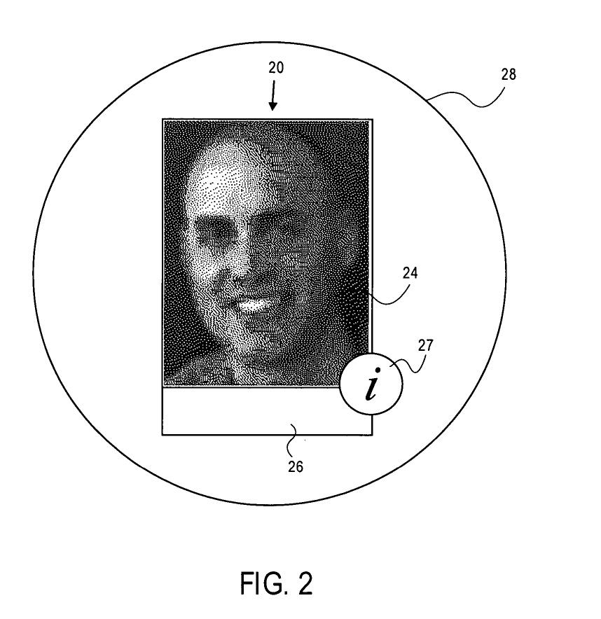

FIG. 1 of the accompanying drawings illustrates a computer screen displaying a rectangular communication interface 12 according to an embodiment of the invention, which includes a larger round contacts area 14 on the left and a smaller rectangular communication area 16 on the right.

The contacts area 14 includes a plurality of concentric circles 18, multifunction icons 20, and a send-to-all icon 21. Each graphic represents a respective contact. The multifunction icons 20 are arranged in orbit patterns. Placement of the multifunction icons 20 is related to frequency of communication; graphics placed nearer the center of the contacts area 14 are used more. Placement of the multifunction icons 20 can be done automatically, as a user may place the multifunction icons 20 in any decided location. A center-positioned icon 22 represents the local user. The send-to-all icon 21 is reserved in the outermost orbit in the six o'clock position.

As illustrated in FIG. 1, each one of the multifunction icons 20 includes a contact graphic 24, an archive function area 26, and an information function area 27. By clicking on the contact graphic 24, a ring 28 is created around the multifunction icon 20, for example, for purposes of creating a message to a person corresponding to the multifunction icon 20. Clicking on the archive function area 26 allows for listening to messages from the user corresponding to the multifunction icon 20. Clicking on the information function area 27 allows for retrieval of information of the user corresponding to the multifunction icon 20.

Referring again to FIG. 1, each one of the contact graphics 24 may be either a drawn icon 30 or a picture 32 of the particular user.

Selecting a multifunction icon 20 with a mouse-click creates a ring 28 around the multifunction icon 20. The user may remove the ring 28 by re-clicking on the multifunction icon 20. More than one multifunction icon 20 may have a ring 28 around it at one time. Clicking the send-to-all icon 21 creates a ring around each multifunction icon 20.

The communication area 16 includes three overlapping message-creating fields 40, 42, and 44. Each field 40, 42, and 44 has a main portion 46 and a tab 48 at the top of the respective main portion 46. Mouse-clicking on a respective tab 48 brings the main portion 46 to the forefront view. The tabs 48 have visual identifiers, images, that represent their different functions. The message-creating field 40 is in the forefront view, and its respective tab has an image of a “smiley” face with a speech bubble.

Message-Creating Field

The message-creating field 40 includes controls and indicators for creating and playing audio messages 50, 52, 54, 56,58, 60, 62, and 64, fields for creating textual messages 66 and 68, and a help icon 70.

The message-creating field 40 has a mouse-selectable record icon 50, stop icon 52, play icon 54, and send icon 56 respectively arranged in a left-to-right horizontal pattern near the top of communication area 16. These icons are associated with creating and sending audio messages. The record icon 50 is an image of a square button with a circle in the middle, and is labeled “record.” The stop icon 52 is an image of a square button with a square in the center, and is labeled “stop.” The play icon 54 is an image of a square button with an isosceles triangle in the center, and is labeled “play.” The send icon 56 is an image of a postal letter, and is labeled “send.” At the bottom of the message-creating field 40 is a mouse-selectable delete icon 58. The delete icon is in the form of a rectangular button and is labeled “clear.”

A colored time bar 60 is located beneath the icons. The length of the colored time bar 60 is a visual guide to the duration of a message. A numerical indicator 62 is located beneath the colored time bar 60 to show the numerical length of the message in units of minutes and seconds, “X:XX.” A mouse-selectable volume icon 64 is located to the right of the colored time bar 60. Selecting this icon will bring up controls (not shown) to adjust the play-back volume of a message.

A small rectangular header section 66 is located beneath the colored time bar 60. This field may be selected with a mouse and text entered into it to create a header line of a message. A larger text section 68 is located beneath the header section 66. The text section 68 may be selected with a mouse and text entered into it to create a body of a written message.

At the bottom of the message-creating field 40 is the mouse-selectable help icon 70. The help icon 70 is in the form of a rectangular button and is labeled “show me how.” When the user selects the help icon 70, an instructional interface appears (not shown) to show the user how to use the controls.

Listen Field

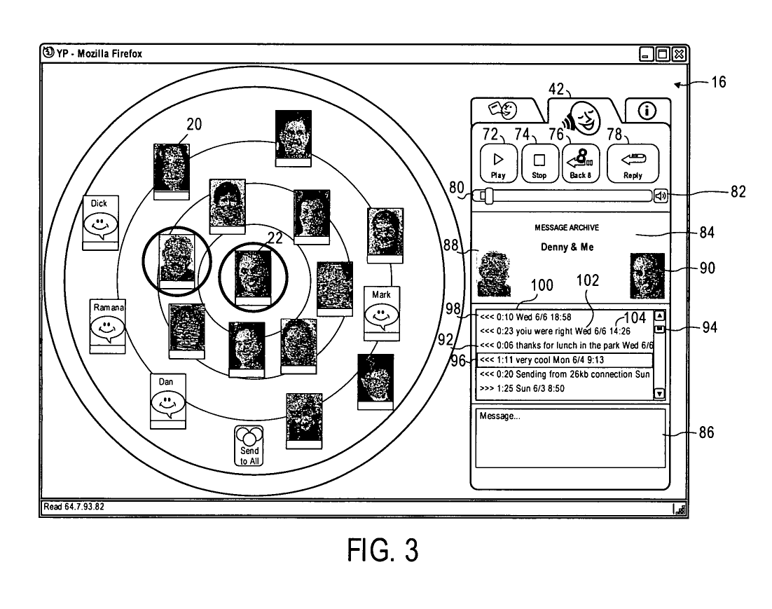

FIG. 3 shows the rectangular communication interface 12 largely described as in FIG. 1. In FIG. 3 the rectangular communication area 16 has the listen field 42 in the forefront view, and its respective tab has an image of a “smiley face” listening to a sound wave.

The listen field 42 includes controls and indicators for listening to audio messages 72, 74, 76, 78, 80, and 82, an archive section 84, and a text field 86.

The listen field 42 has a mouse-selectable play icon 72, stop icon 74, back-8 icon 76, and reply icon 78 respectively arranged in a left-to-right horizontal pattern near the top of communication area 16. These icons are associated with listening to received messages. The play icon 72 is an image of a square button with an isosceles triangle in the center, and is labeled “play.” The stop icon 74 is an image of a square button with a square in the center, and is labeled “stop.” The back-8 icon 76 is an image of a square button with a left-facing arrow combined with an “8,” and is labeled “back-8.” The reply icon 78 is an image of a rectangular button with a left-facing arrow on it, and is labeled “reply.”

A play-back bar 80 is located beneath the icons. The position of the bar 80 is a visual guide to the duration of a message. A mouse-selectable volume icon 82 is located to the right of the play-back bar 80. Selecting the icon 82 will bring up controls (not shown) to adjust the play-back volume of a message.

Beneath the play-back bar 80 is a message archive section 84. The message archive section 84 includes identifiers 88 and 90, and data lines 92. The message archive section 84 is an historical record for all messages sent between the user and a current chosen contact. A different message archive exists for each contact. The current chosen contact's identifier 88 appears next to the user's identifier 90 in the message archive.

The data lines 92 are stacked horizontally and listed in chronological order, with the newest data line 92 on top. The data line 92 displays descriptive information for a single respective message. A scroll bar 94 allows the user to view older data lines stacked near the bottom, because the archive may have a plurality of data lines which cannot be displayed simultaneously. Clicking on a data line 92 highlights it. A highlighted data line 96 is playable using the controls and indicators 72, 74, 76, 78, 80, and 82.

A data line 92 is a single line of text including arrows 98, a time indicator 100, a subject header 102, and a date indicator 104. The arrows 98 are located on the left-most portion of each data line 92. The arrows 98 signify whether the message was sent to the user or sent by the user. The arrows 42 face left or right, “<<<” for outgoing messages and “>>>” for incoming messages. Located in line and to the right of the arrows 98 is the time indicator 100, which lists a numerical description of the length of time of an audio message, in minutes and seconds, “X:XX.” Located in line and to the right of the time indicator 100 is a subject header 102. The subject header is a short text description of the message. Located in line and to the right of the subject header is the date indicator 104. The date indicator 104 displays when the message was sent, date and time of day.

Beneath the message archive section 84 is a text field 86. This section displays the text of the highlighted data line 96.

Information Field

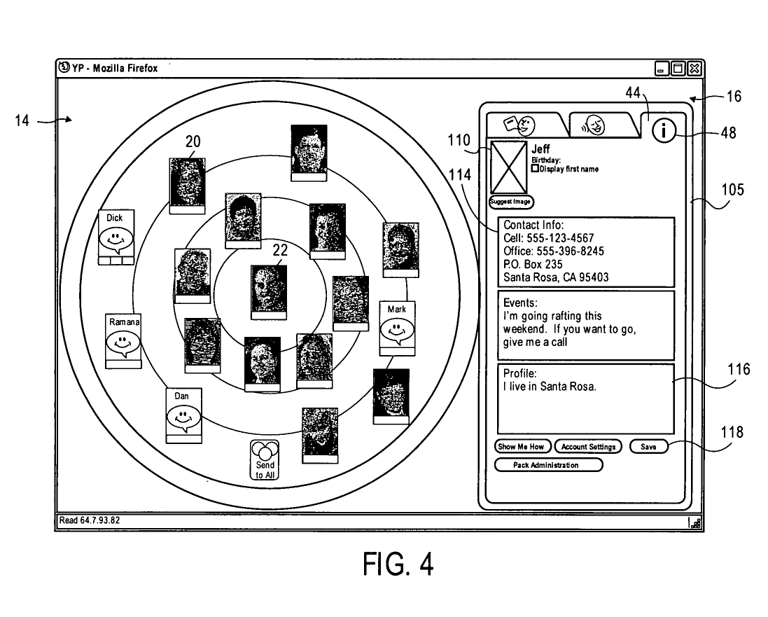

FIG. 4 shows the rectangular communication interface 12 largely described as in FIG. 1. In FIG. 4 the rectangular communication area 16 has the information field 44 in the forefront view, and its respective tab has a picture of a circled “i.”

A contact profile area 105 of the information field 44 includes an identifier 110, and a contact profile 114. The identifier 110 is located above the contact profile 114, and identifies the contact profile area 105 by name. The contact profile 114 is textual information the user wishes to be published for other users to see.

Creating and Sending a Message

In use, the user uses the message-creating field 40 to create and send a message. The user directs input devices, such as a mouse or a keyboard, to move a cursor on the computer screen and click on icons.

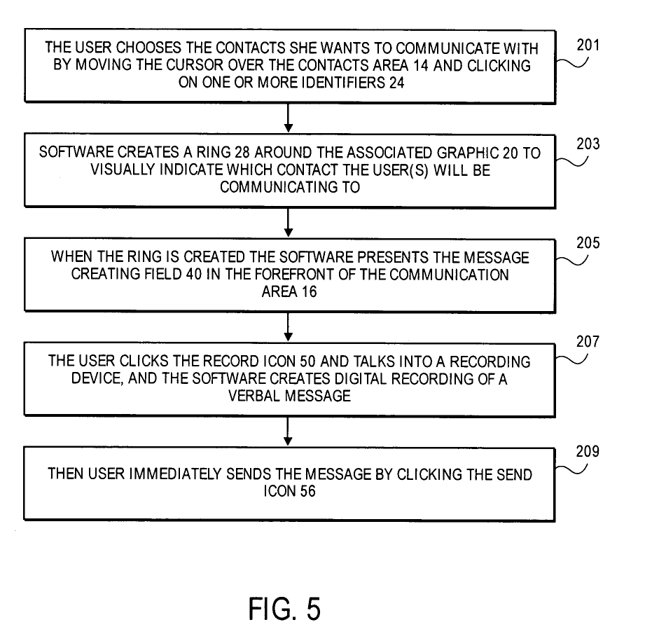

As shown in FIG. 5, the user chooses the contacts he/she wants to communicate with by moving the cursor over the contacts area 14 and clicking on one or more contact graphics 24 (201). When the user clicks on a contact graphic 24, software creates a ring 28 around the associated multifunction icon 20 to visually indicate which contact the user will be communicating to (203). Re-clicking on a contact graphic 24 with a ring 28 around it will remove the ring 28. The user may click on as many contact graphics 24 as he/she wishes. The user may click on the send-to-all icon 21 to create rings 28 around all the multifunction icons 20.

When the ring 28 is created, the software brings the message-creating field 40 to the forefront of the communication area 16 (205). The user may click and type in the header section 66 to create a header. The user may click and type in the text section 68 to create a textual message. The user is not required to create a textual message and header in order to send an audio message.

To create a message, the user clicks the record icon 50 and talks into a recording device, and the software creates a digital recording of an audio message (207). Then the user may immediately send the message by clicking the send icon 56, upon which the software will automatically stop the recording and send the digital recording, as recorded up to the point of clicking the send icon (209). No other action is required between 207 and 209.

The user may alternatively click the stop icon 52 to stop recording, and then later send, delete, or listen to the message. The user deletes the message by clicking the delete icon 58. The user listens to the audio message by clicking the play icon 54; the message will play completely through unless the user selects the stop icon 52. The user may also drag the colored time bar 60 to change the play-back position of the message. After, or during, listening to the message the user may send or delete the message as described above.

Creating Messages Using the Multifunction Icon

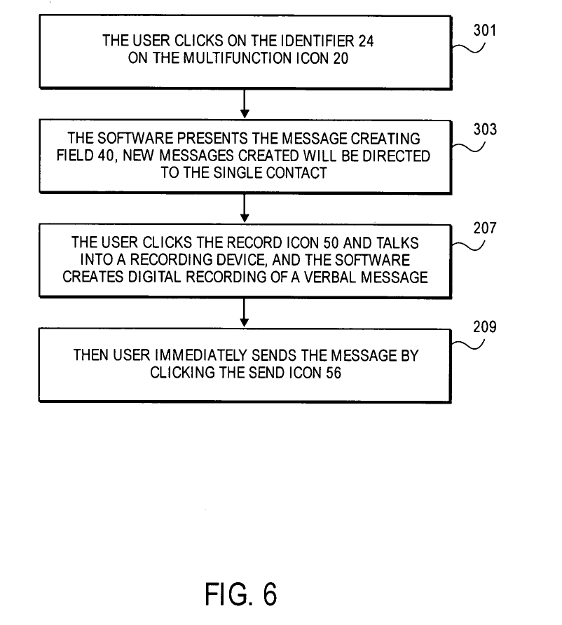

In use, the contact graphic 24 is used to create a message for a single contact or multiple contacts, as shown in FIG. 6. The user clicks the function contact graphic 24 of one or more selected multifunction icons 20 (301), upon which the software presents the message-creating field 40; new messages created will be directed to the corresponding contact or contacts (303). The user may click on the send-to-all icon 21 to create rings 28 around all the multifunction icons 20. The user creates, sends, deletes, or listens to the message as described above (207), (209).

Listening to Messages

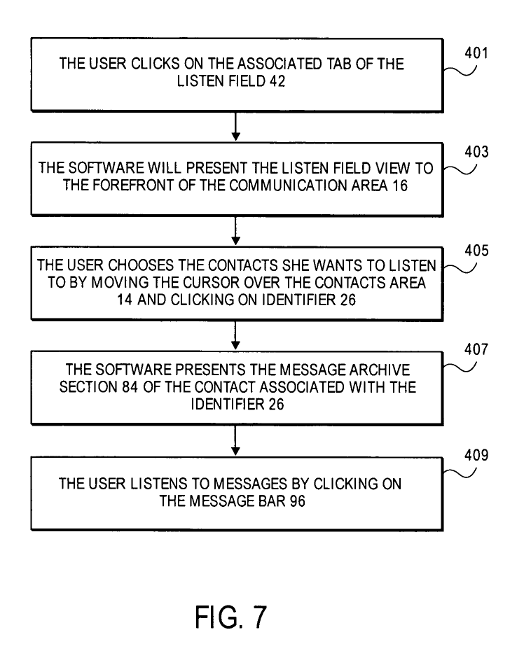

In use, the user uses the listen field 42 to read and listen to messages sent to the user by his/her contacts. As shown in FIG. 7, the user clicks on the associated tab of the listen field 42 (401), upon which the software will bring the listen field view to the forefront of the communications area 16 (403).

The user can choose the contacts he/she wants to listen to by moving the cursor over the contacts area 14 and clicking on a contact graphic 24 (405). When the user clicks on the contact graphic 24, the software presents the message archive section 84 of the contact associated with the multifunction icon 20 (407).

The user listens to messages by pressing the play icon 72 (409). The most recent message will automatically play. If the message has any associated text, the text will appear in the text field 86. The user may click on other data lines 92 to listen and read older messages. A user may alternatively play a particular message by clicking on a particular data line 92.

The user stops message play-back by clicking the stop icon 74. During play-back the user may click on the back-8 button 76 to rewind the message eight seconds. The user may also drag the play-back bar 80 to change the play-back position of the message.

The user replies to the contact by clicking the reply icon 78 to bring the message-creating field 40 to the forefront of the communications area 16. The user may then create a message as described above.

Listening to Messages Using the Multifunction Icon

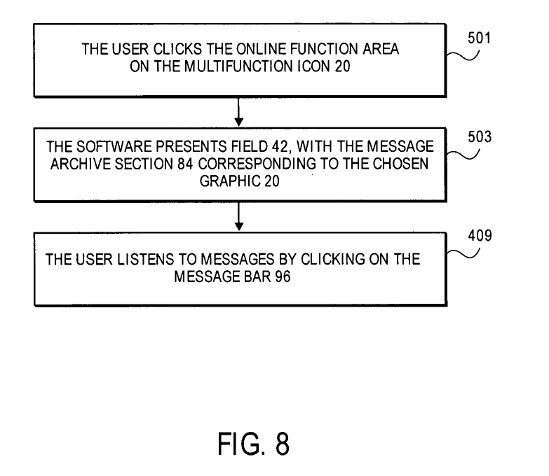

In use, the multifunction icon 20 is used to listen to a message from a single contact as shown in FIG. 8. The user clicks the archive function area 26 on the selected multifunction icon 20 (501), upon which the software will present listen field 42, with the message archive section 84 corresponding to the chosen multifunction icon 20 (503). The user listens to the message as described above (409).

Discussion Groups

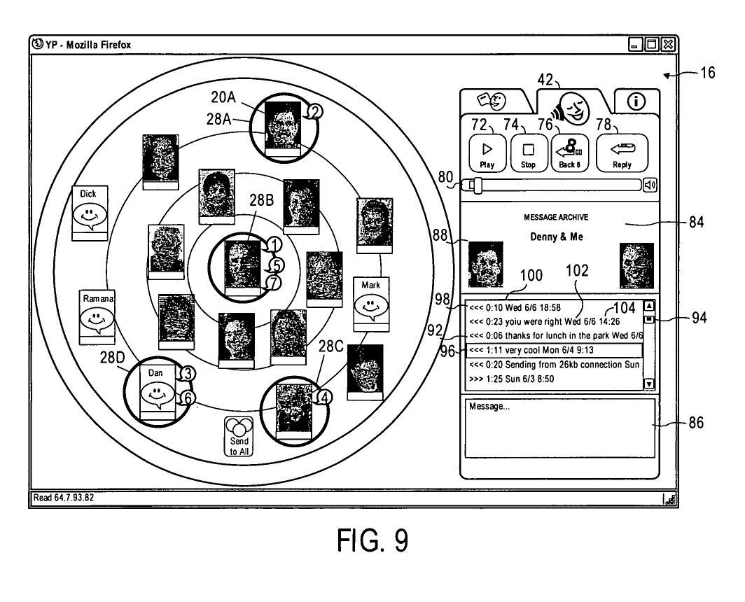

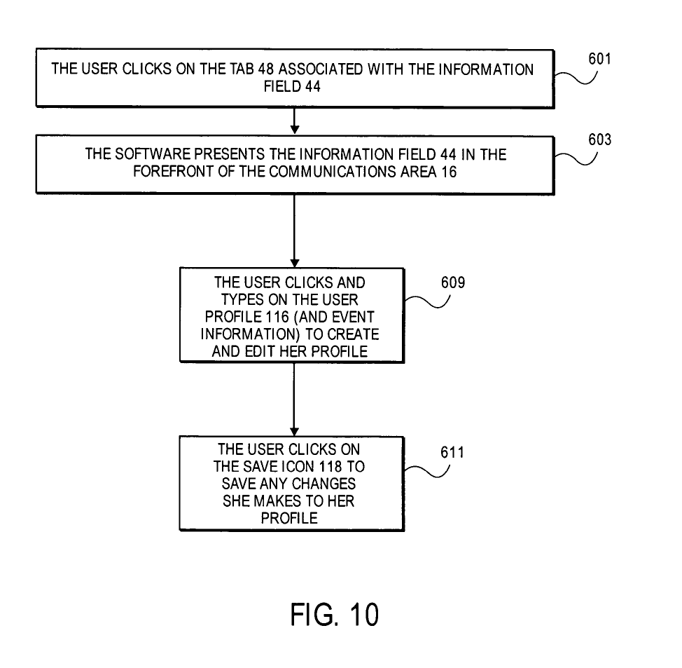

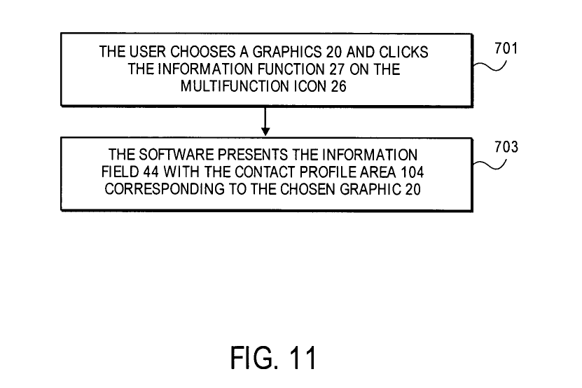

As illustrated in FIG. 9, a data line 96 is selected out of an archive section 84 corresponding to a multifunction icon 20A at the top. The particular message 96 was sent to three recipients. The three recipients and the person who sent the message have rings 28A, 28B, 28C, and 28D around their respective multifunction icons 20. A user can thus identify every user to whom the message was sent, and thus form part of a discussion group.

In addition, the rings 28A, 28B, 28C, and 28D have different colors depending on whether the user to whom the message was sent has opened the message. For example, the rings 28A and 28C can be grey to represent that the users corresponding to the rings 28A and 28C did open and listen to a message, and the rings 28B and 28D can be green to represent that the users corresponding to the rings 28B and 28D have not yet listened to the message.

Message Threads

The particular message 96 may be a single one in a thread of messages. A message thread is started when a user replies to all who received the first message. In the present example, a first message was sent by a user corresponding to the ring 28B. The user corresponding to the ring 28A then responded to the message sent by the user corresponding to the ring 28B. Other users then responded in a linear thread until seven messages were created. The user who sent the first message has a circled “1” on the ring 28B, the user who sent the second message has a circled “2” on the ring 28A, the person who sent the third message has a circled “3” on the ring 28D, and so on. A particular user may respond more than once in a particular thread; for example, the users corresponding to the rings 28A and 28D. The symbols represented by the circled “1” to the circled “7” provide a user with information regarding how the message thread evolved between different users. The local user can click on each one of the circles “1” to “7,” typically in the order from 1 to 7, to follow the discussion. Each ring 28 has a filled-in background of a particular color, denoting to which messages the user has listened, and to which messages the user has not listened. Grey may, for example, indicate that the user has listened to a particular message, and green may indicate that the user has not listened to a particular message. A message is automatically played when a user clicks on a circle “1” to “7,” in which case the background turns to a third color, for example, yellow. Not shown in the drawings, it may also be possible to branch from a linear thread and, for example, create circles “4A” and “4B.”

Information

In use, the local user uses the information field 44 to view contact profiles and to create and edit his/her profile. As shown in FIG. 8, the local user clicks on the tab 48 associated with the information field 44 (601), upon which the software will bring the information field 44 to the forefront of the communications area 16 (603).

The local user clicks and types on a user profile 116 to create and edit his/her profile (609). The local user clicks on a save icon 118 to save any changes he/she makes to his/her profile (611). The local user's profile has been published for others to see.

Similarly, other users can enter their own profiles and have them published for the local user to see. The local user can obtain a profile of another user by clicking on the information function area 27 corresponding to a selected multifunction icon 20. The data published by another user is not modifiable by the local user. Additional fields are provided for the local user to enter additional information about another user.

Getting Information Using the Multifunction Icon

In use, the multifunction icon 20 is used to quickly view a profile of a single contact. The user chooses a multifunction icon 20 and clicks the information function 36 on the multifunction icon 20 (701), upon which the software will present the information field 44 with the contact profile area 105 corresponding to the chosen multifunction icon 20 (703).

Computer System

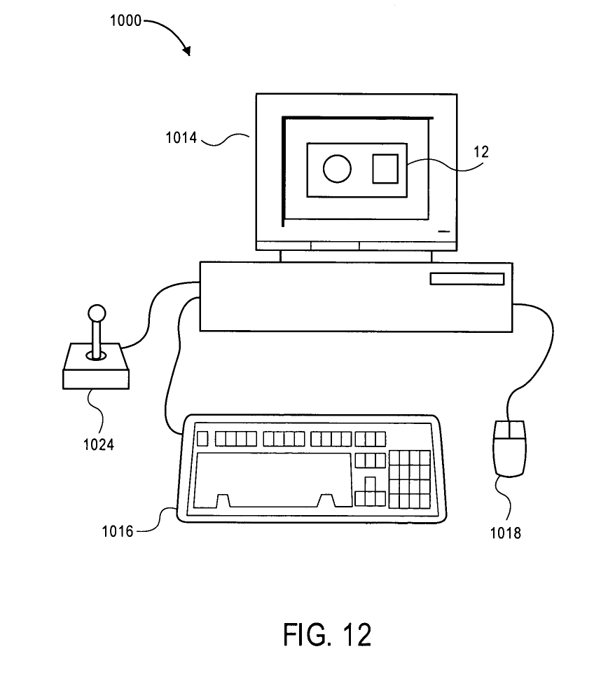

In use, the communications interface 12 is used on a client computer system 1000, such as a personal computer, as shown in FIG. 12. The communications interface 12 is shown on a monitor video display, such as a monitor. The user uses the keyboard 1016, mouse 1018, and recording device as described above.

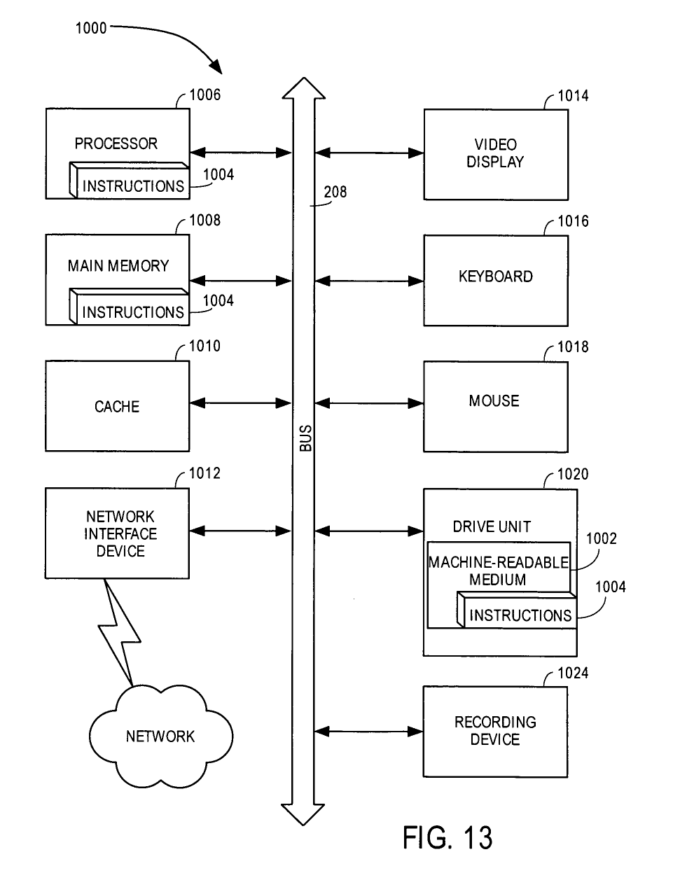

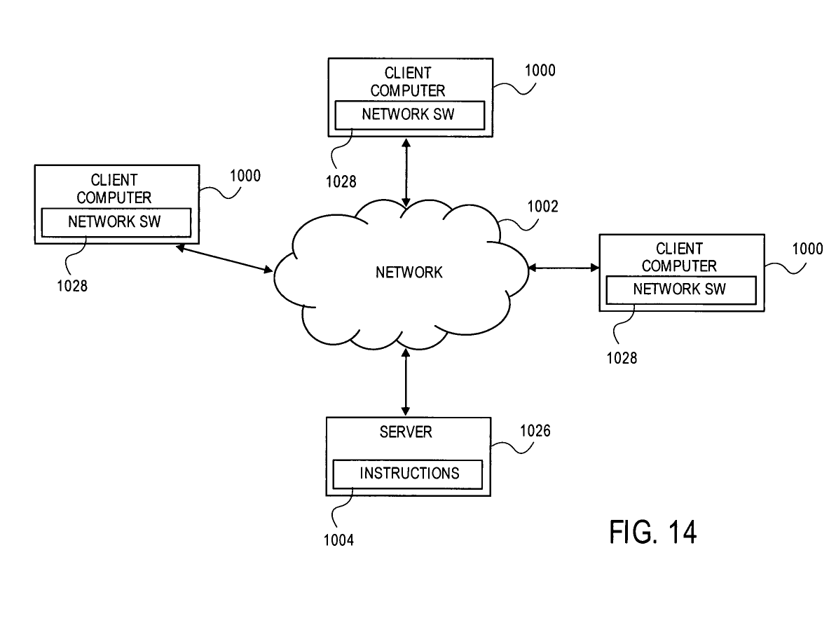

In use, the interface is used on a plurality of client computer systems 1000 connected to a network 1002, as shown in FIG. 13. The client computer 1000 includes instructions 1004, such as software or computer-readable program code, which enables communication over the network 1002, as described above. The client computer includes subsystems 1006, 1008, 1010, 1012, 1016, 1018, 1020, 1024, and circuitry integrated by a bus 1026.

The processor 1006 processes the instructions 1004 and instructs the other subsystems. The main memory 1008, such as RAM, stores the instructions on a temporary basis. Cache 1010 stores recently used files which the processor 1006 can access quickly. The network access device, such as a modem or network card, interfaces with the network to enable communication with other users. The video display 1014 displays the interface as described above. The keyboard 1016, mouse 1018, and recording device 1024 receive user inputs as described above. The drive unit such as a floppy drive, tape drive, flash memory drive, or hard disk drive, includes a machine-readable medium 1022, such as a floppy disk, tape, flash memory, or hard disk, and is used to permanently store the instructions 1004.

Alternatively, the instructions 1004 may be stored on a server 1026 as shown in FIG. 13. Client computer systems 1000 access the instructions 1004 on the server 1026 through a network, such as the Internet, via the network interface card 1012. The instructions are stored on the server similarly to the client computer systems 1000, as described above. The user accesses the interface over the network 1002 through network software 1028, such as a web browser.

Advantages

In use, the interface as described above facilitates communication. Audio and written messages may be sent and received rapidly over the Internet via the interface described above. The interface offers many advantages for users.

One advantage of the interface is visual indication of which contact the user will be sending a message to. As described above, clicking on a contact graphic 24 creates a ring around the multifunction icon 20. Thus a user can easily identify which contact he/she will be creating a message for by simply looking at the computer screen.

Another advantage is that the interface enables rapid delivery of audio communications. As described above, the user rapidly sends a recorded message to another user by simply clicking on the record icon 50, speaking into a recording device, and clicking the send icon 56.

Another advantage is that the interface enables the user to keep a historical record of his/her communications. As described above, the user uses the listen field to listen to new and past messages from any of his/her contacts.

Another advantage is that the interface enables the user to view contact information. As described above, the user uses the information field to view contact profiles as well as record and update his/her own contact profile.

Another advantage is that the user may also use the multifunction icon 20 to quickly and easily communicate with a single contact. Clicking on the contact graphic 24 enables the user to quickly create and send a message to one contact. Clicking on the archive function area 26 enables the user to quickly listen to a message from one contact. Clicking on the information function area 27 enables the user to quickly view information about the contact.

Another advantage is that a user may participate in a threaded audio discussion.

Another advantage is that the interface is used over a network, such as the Internet. Thus the user may access the interface through any client computer system connected to the Internet.

Many of the technologies described herein can manifest themselves in different hardware or software than described. For example, a mobile device can be used with hand buttons as input, a kiosk may use a touch screen as an input device, and a television can use a remote control as an input device. It may also be possible to use some of these technologies without a computer interface, for example when sending or listening to messages over a telephone, in which case an interactive voice recognition system can be used.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A method of displaying a message section on a computer screen, comprising:
displaying a plurality of graphics, each having a graphic representing at least one recipient and having an information portion which has a plurality of functions, on a computer screen;
picking one of the functions; and
displaying the message section on the computer screen in response to the picking of one of the functions, the message section having controls for creating and receiving messages relating to the recipient.

2. The method of claim 1, wherein the graphic is an icon.

3. The method of claim 1, wherein the graphic is a picture.

4. The method of claim 1, wherein the information portion is located at the bottom portion of the graphic.

5. The method of claim 1, wherein one of the functions is an icon.

6. The method of claim 1, wherein picking one of the functions is executed from a mouse-click.

7. The method of claim 1, wherein displaying a message section on the computer screen occurs after picking one of the functions.

8. The method of claim 1, wherein one of the functions relates to the controls for creating messages.

9. The method of claim 8, wherein the controls for creating messages includes controls to create, play, and send messages.

10. The method of claim 1, wherein one of the functions relates to the controls for receiving messages.

11. The method of claim 10, wherein the controls for receiving messages includes controls for playing, stopping, and replying to messages.

12. The method of claim 11, additionally comprising a control to rewind a message at set time intervals.

13. The method of claim 11, wherein the message is verbal.

14. The method of claim 1, wherein the message section additionally comprises controls for archiving messages.

15. The method of claim 1, wherein the message section additionally comprises controls for setting preferences.

16. A computer program comprising a computer-useable medium having computer-readable program code embedded therein for displaying a message section on a computer screen, comprising:
computer-readable program code configured to display a plurality of graphics, each having a graphic representing at least one recipient and having an information portion which has a plurality of functions, on a computer screen;
computer-readable program code configured to enable a user to pick one of the functions; and
computer-readable program code configured to display the message section on the computer screen in response to the picking of one of the functions, the message section having controls for creating and receiving messages relating to the recipient.

17. A system for displaying a message section on a computer screen, comprising at least one client computer system configured to:
display a plurality of graphics, each having a graphic representing at least one recipient and having an information portion which has a plurality of functions, on a computer screen;
enable a user to pick one of the functions; and
display the message section on the computer screen in response to a user picking of one of the functions, the message section having controls for creating and receiving messages relating to the recipient.

18. A system for displaying a message section on a computer screen; comprising a plurality of client computer systems configured to:
display a plurality of graphics, each having a graphic representing at least one recipient and having an information portion which has a plurality of functions, on a computer screen;
enable a user to pick one of the functions;
display the message section on the computer screen in response to a user picking of one of the functions, the message section having controls for creating and receiving messages relating to the recipient;
at least one server computer system configured to facilitate sending and receiving of the message between the client computer systems; and
at least one network to transmit the message thereon.
